(19) United States
(12) Patent Application Publication
(10) Pub. No.: US 2026/0161169 A1
(43) Pub. Date: Jun. 11, 2026

(54) FLIGHT CONTROL DEVICE, FLIGHT CONTROL METHOD, AND UNMANNED AERIAL VEHICLE

(71) Applicant: RAKUTEN GROUP, INC., Tokyo (JP)

(72) Inventor: Asaki MATSUMOTO, Tokyo (JP)

(73) Assignee: RAKUTEN GROUP, INC., Tokyo (JP)

(21) Appl. No.: 18/976,458

(22) Filed: Dec. 11, 2024

(30) Foreign Application Priority Data
Dec. 28, 2023 (JP) 2023-223105

(51) Int. Cl. G05D 1/622; G05D 1/248; G05D 1/48; G05D 105/28; G05D 109/25; G05D 111/30

(52) U.S. Cl. CPC G05D 1/622; G05D 1/248; G05D 1/48; G05D 2105/28; G05D 2109/254; G05D 2111/30

(57) ABSTRACT

The UAV 1 sequentially acquires, as satellite information relating to one or more positioning satellites, a parameter value that is the indicator of the positioning accuracy on the basis of information on radio waves from the captured positioning satellites while the UAV 1 is flying, identifies a first obstacle that prevents reception of the radio waves in a vicinity of the UAV 1 in flight in response to that the parameter value falls under the situation indicating the reduction of the positioning accuracy, and flies so as to move away from the identified first obstacle.

### CROSS REFERENCE TO RELATED APPLICATION

This application claims priority from Japanese Patent Application No. 2023-223105 which was filed on Dec. 28, 2023, the disclosure of which is herein incorporated by reference in its entirety.

### TECHNICAL FIELD

One or more embodiments of the present invention relate to a technical field of an unmanned aerial vehicle capable of autonomously flying by receiving radio waves (signals) from positioning satellites.

### RELATED ART

Conventionally, an autonomous flight using a satellite positioning system has become mainstream for an unmanned aerial vehicle such as a drone, but an issue has been how to achieve the autonomous flight in environments where positioning satellites cannot be captured. For example, JP 2018-147467 A discloses a technology that causes, even if flying along a planned route would result in reduction (decrease) of positioning accuracy, an unmanned aerial vehicle to fly on a different route than the planned route. According to this technology, it is possible to avoid the reduction of the positioning accuracy, and to allow the unmanned aerial vehicle to continue flying while detecting its positions.

By the way, in places with many obstacles preventing reception of radio waves from positioning satellites, especially in urban areas where a drone delivery is expected to be utilized in the future, since many buildings (e.g., high-rise buildings) are crowded together, the number of the positioning satellites that can be captured would reduce and the positioning accuracy would reduce. As a result, there are concerns that the safety of the aerial vehicle may be compromised, the delivery may be affected, or the like. By also changing of a placement state of the positioning satellites orbiting the earth, since the positioning accuracy may reduce, there are concerns that the safety of the aerial vehicle might be compromised, the delivery might be affected, or the like.

Therefore, one or more embodiments of the present invention are to providing a flight control device, a flight control method, and an unmanned aerial vehicle, which are capable of safely performing flight control of the unmanned aerial vehicle even in a place with many obstacles that prevent reception of radio waves from positioning satellites.

### SUMMARY

(An aspect 1) In response to the above issue, a flight control device according to an aspect 1 includes: at least one memory configured to store program code; and at least one processor configured to access the program code and operate as instructed by the program code. The program code includes: acquisition code configured to cause the at least one processor to sequentially acquire, as satellite information relating to one or more positioning satellites, a parameter value that is an indicator of positioning accuracy on the basis of information on radio waves from the positioning satellites captured by an unmanned aerial vehicle in flight; identification code configured to cause the at least one processor to identify a first obstacle that prevents reception of the radio waves in a vicinity of the unmanned aerial vehicle in response to that the parameter value falls under a situation that indicates reduction of the positioning accuracy; and flight control code configured to cause the at least one processor to perform flight control of the unmanned aerial vehicle so as to move away from the identified first obstacle.
(An aspect 2) A flight control method according to an aspect 2 is executed by one or more computers and includes: sequentially acquiring, as satellite information relating to one or more positioning satellites, a parameter value that is an indicator of positioning accuracy on the basis of information on radio waves from the positioning satellites captured by an unmanned aerial vehicle in flight; identifying a first obstacle that prevents reception of the radio waves in a vicinity of the unmanned aerial vehicle in response to that the parameter value falls under a situation that indicates reduction of the positioning accuracy; and performing flight control of the unmanned aerial vehicle so as to move away from the identified first obstacle.
(An aspect 3) An unmanned aerial vehicle according to an aspect 3 includes: at least one memory configured to store program code; and at least one processor configured to access the program code and operate as instructed by the program code. The program code includes: acquisition code configured to cause the at least one processor to sequentially acquire, as satellite information relating to one or more positioning satellites, a parameter value that is an indicator of positioning accuracy on the basis of information on radio waves from the positioning satellites captured by an unmanned aerial vehicle in flight; identification code configured to cause the at least one processor to identify a first obstacle that prevents reception of the radio waves in a vicinity of the unmanned aerial vehicle in response to that the parameter value falls under a situation that indicates reduction of the positioning accuracy; and flight control code configured to cause the at least one processor to perform flight control of the unmanned aerial vehicle so as to move away from the identified first obstacle.

### BRIEF DESCRIPTION OF THE DRAWINGS

FIG. 1 is a diagram illustrating a schematic configuration example of a flight control system S.

FIG. 2 is a diagram illustrating a schematic configuration example of an UAV 1.

FIG. 3 is a diagram illustrating an example of functional blocks in a control unit 16.

FIG. 4 is a conceptual diagram illustrating the UAV 1 ascending vertically (θ=90 degrees).

FIG. 5 is a conceptual diagram illustrating the UAV 1 ascending to an oblique upward direction (0 degrees<θ<90 degrees).

FIG. 6 is a conceptual diagram illustrating the UAV 1 ascending at an ascent angle that will not collide with the obstacle OB3 located on the opposite side of the obstacle OB2.

FIG. 7 is a conceptual diagram illustrating an example of a central portion between the obstacle OB2 and the obstacle OB3.

FIG. 8 is a conceptual diagram illustrating the UAV 1 gradually descending to the waypoint WP3 after reduction of positioning accuracy is recovered.

FIG. 9 is a conceptual diagram illustrating the UAV 1 flying toward the waypoint WP3 where reduction of positioning accuracy is forecasted to be recovered.

FIG. 10 is a diagram illustrating a schematic configuration example of the flight management server 2.

FIG. 11 is a flowchart illustrating an example of a flight control processing executed by the control unit 23 of the flight management server 2 in Example 1.

FIG. 12 is a flowchart illustrating an example of a flight control processing executed by the control unit 23 of the flight management server 2 in Example 2.

### DETAILED DESCRIPTION

Hereinafter, one or more embodiments of the present invention will be described with reference to the drawings. The following embodiment is an embodiment in a case where the present invention is applied to a flight control system that controls the flight of an unmanned aerial vehicle (hereinafter referred to as an UAV (Unmanned Aerial Vehicle)) capable of autonomously flying by receiving radio waves from positioning satellites.

### 1. Configuration and Operation Outline of Flight Control System S

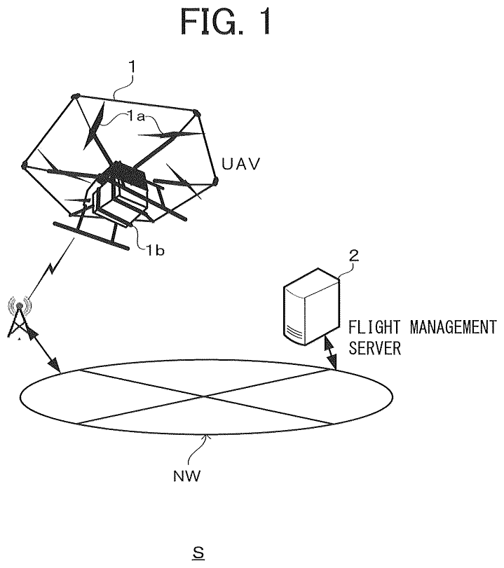

First, a configuration and operation outline of a flight control system S according to the present embodiment will be described with reference to FIG. 1. FIG. 1 is a diagram illustrating a schematic configuration example of the flight control system S. As illustrated in FIG. 1, the flight control system S includes an UAV 1, a flight management server 2, and the like. The UAV 1 is also called a drone or a multicopter. Incidentally, in the example of FIG. 1, one UAV 1 is shown, but in reality there are multiple UAVs 1. The UAV 1 is capable of taking off according to take-off instructions from a GCS (Ground Control Station) and flying autonomously. The UAV 1 is used for, for example, delivery, surveying, photographing, monitoring, and the like. Incidentally, the UAV 1 can also fly according to remote control from the ground by using a pilot (control) terminal installing the GCS. The flight management server 2 is a server that manages a flight route and flight schedule of the UAV 1, and can also perform flight control of the UAV 1. The UAV 1, the flight management server 2, and the like are each connected to a communication network NW. The communication network NW includes, for example, the Internet, a mobile communication network, a radio base station thereof, and the like.

### 1-1. Configuration and Function of UAV 1

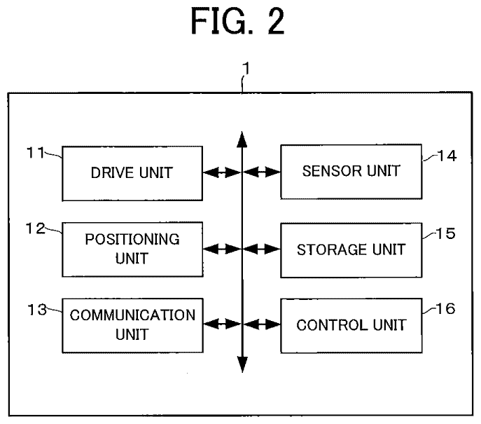

Next, a configuration and a function of the UAV 1 will be described with reference to FIG. 2. FIG. 2 is a diagram illustrating a schematic configuration example of the UAV 1. As illustrated in FIG. 2, the UAV 1 includes a drive unit 11, a positioning unit 12, a communication unit 13, a sensor unit 14, a storage unit 15, a control unit 16 (an example of a flight control device), and the like. Moreover, the UAV 1 includes a battery that supplies power to each unit of the UAV 1. Furthermore, as illustrated in FIG. 1, the UAV 1 includes rotors (propeller) 1a that are a plurality of horizontal rotary blades (wings) and a holding member 1b that holds one or more articles (e.g., items to be delivered) loaded. The drive unit 11 includes a motor, a rotation shaft, and the like. The drive unit 11 rotates a plurality of rotors 1a by the motor, the rotation shaft, and the like that are driven in accordance with a control signal output from the control unit 16.

The positioning unit 12 includes a radio wave receiver and the like. The positioning unit 12 receives radio waves transmitted from positioning satellites of a GNSS (Global Navigation Satellite System) by the radio wave receiver, and detects a current position of the UAV 1 on the basis of the radio waves. The current position of UAV 1 may be expressed by the latitude and longitude (i.e., two-dimensional coordinates) of UAV 1, or by the latitude, longitude, and altitude (i.e., three-dimensional coordinates) of the UAV 1. Here, the altitude detected by the positioning unit 12 is the height from a revolving ellipsoid defined in the world geodetic system such as WGS (World Geodetic System) 84, but this altitude may be interpolated to a value indicating the height from the ground in an area in which the UAV 1 is flying, by known interpolation calculations. Incidentally, the positioning satellites may include satellites used by a plurality of satellite positioning systems, such as GPS (Global Positioning System) satellites, Michibiki (QZSS: Quasi-Zenith Satellite System) satellites, and Galileo satellites. The current position detected by the positioning unit 12 is sequentially (continuously) output to the control unit 16. At this time, information (e.g., radio wave intensity, reception angle, etc.) on radio waves from the positioning satellites captured by the positioning unit 12 is sequentially output to the control unit 16. The capturing the positioning satellite means receiving satellite signals transmitted from the positioning satellite at a level equal to or greater than a reference value. The radio wave intensity indicates strength of the radio wave.

The communication unit 13 has a wireless communication function and controls communication performed via the communication network NW. The sensor unit 14 includes various sensors used for flight control and the like for the UAV 1. The various sensors include, for example, an optical sensor, a triaxial angular velocity sensor, a triaxial acceleration sensor, a geomagnetic sensor, and the like. The optical sensor is configured to include a camera (for example, an RGB camera, an infrared camera), and sequentially captures images of real space that falls within an angle of view of the camera. Incidentally, the optical sensor may include a LiDAR (Light Detection and Ranging, or Laser Imaging Detection and Ranging) sensor that measures a shape of a ground feature (planimetric feature) or a distance to a ground feature. Sensing information detected by the sensor unit 14 is sequentially output to the control unit 16.

The storage unit 15 includes a nonvolatile memory or the like, and stores various programs (program code group) including an operating system and applications, and data. Here, the applications include a program for performing a flight control method. Moreover, the storage unit 15 stores a vehicle ID of the UAV 1. The vehicle ID is identification information for identifying the UAV 1. The control unit 16 includes at least one CPU (Central Processing Unit), a ROM (Read Only Memory), a RAM (Random Access Memory), and the like. The CPU (an example of processor) is configured to access the program code stored in the storage unit 15 or the memory and operate as instructed by the program code. The program code includes: acquisition code configured to cause the at least the CPU to sequentially acquire, as satellite information relating to one or more positioning satellites, a parameter value that is an indicator of positioning accuracy on the basis of information on radio waves from the positioning satellites captured by the UAV 1 in flight; identification code configured to cause the at least one processor to identify a first obstacle that prevents reception of the radio waves in a vicinity of the UAV 1 in response to that the parameter value falls under a situation that indicates reduction of the positioning accuracy; and flight control code configured to cause the at least one processor to perform flight control of the UAV 1 so as to move away from the identified first obstacle. Incidentally, the processor may be implemented using circuitry or processing circuitry which includes general purpose processors, special purpose processors, integrated circuits, ASICs, conventional circuitry and/or combinations thereof which are configured or programmed to perform the disclosed functionality. The processor may be hardware (or a combination of hardware and software) that carry out or are programmed to perform the recited functionality.

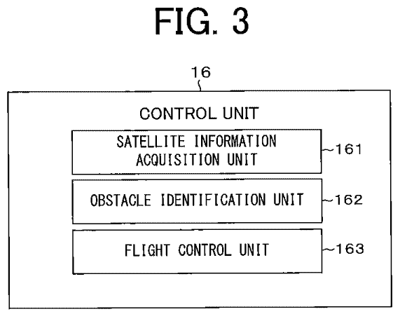

FIG. 3 is a diagram illustrating an example of functional blocks in the control unit 16. For example, the control unit 16 functions as a satellite information acquisition unit 161, an obstacle identification unit 162, and a flight control unit 163, and the like as illustrated in FIG. 3, in accordance with according to the programs (program code) stored in the storage unit 15 or the memory. Incidentally, the control unit 16 sequentially transmits position information indicating the current position of the UAV 1 together with the vehicle ID of the UAV 1 to the flight management server 2 by the communication unit 13.

The satellite information acquisition unit 161 sequentially (continuously) acquires, as satellite information relating to one or more positioning satellites, a parameter value that is an indicator of positioning accuracy, on the basis of information on radio waves from the positioning satellites captured by the positioning unit 12 while the UAV 1 is flying. The parameter value may be the number (hereinafter referred to as “capture number”) of positioning satellites captured by the positioning unit 12. The higher the capture number, the higher the positioning accuracy. Moreover, the parameter value may be the reduction rate of the positioning accuracy (hereinafter referred to as “DOP (Dilution Of Precision)”). For example, the DOP can be calculated by substituting the current position of UAV 1, the altitude angle and direction angle of the captured positioning satellites into a predetermined matrix. The altitude angle and direction angle of the captured positioning satellites can be identified based on information of radio waves from the positioning satellites. The DOP depends on a placement state (e.g., bias) of the positioning satellites. The smaller the DOP, the higher the positioning accuracy. Incidentally, the DOPs include HDOP indicating a reduction rate in horizontal positioning accuracy, and VDOP indicating a reduction rate in vertical positioning accuracy, but both the HDOP and/or the VDOP are used. In a case where both the HDOP and the VDOP are used, for example, the maximum value of the HDOP and the VDOP (or the average value of the HDOP and the VDOP) may be used as the DOP.

The obstacle identification unit 162 sequentially (continuously) checks whether the parameter value (for example, a change in the parameter value) acquired by the satellite information acquisition unit 161 falls under a situation (in other words, a criterion) indicating the reduction (decrease) of the positioning accuracy. And then, the obstacle identification unit 162 identifies a first obstacle (obstruction) that prevents reception of the radio waves in a vicinity (periphery) of the UAV 1 in flight in response to that the parameter value falls under the situation indicating the reduction of the positioning accuracy (e.g., when the positioning accuracy is reduced). In other words, the obstacle identification unit 162 estimates one or more first obstacles (e.g., shielding objects) that are expected to interfere with radio reception. Such situation may be set in advance for each parameter value. For example, in a case where the parameter value is the capture number of the positioning satellites, the obstacle identification unit 162 sequentially compares (an example of checks) the capture numbers acquired sequentially by the satellite information acquisition unit 161 with a first threshold value (e.g., 4), and identifies the first obstacle preventing the reception of the radio waves in the vicinity of the UAV 1 when the capture number is less than the first threshold value (e.g., at timing when the capture number becomes less than the first threshold value), as falling under the situation indicating the reduction of the positioning accuracy. This makes it possible to identify the first obstacle more accurately. Alternatively, when the parameter value is the DOP, the obstacle identification unit 162 may sequentially compare the DOPs acquired sequentially by the satellite information acquisition unit 161 with a second threshold value (e.g., 4), and identify the first obstacle preventing the reception of the radio waves in the vicinity of the UAV 1 when the DOP is larger than the second threshold value (e.g., at timing when the DOP becomes larger than the second threshold value), as falling under the situation indicating the reduction of the positioning accuracy. This also makes it possible to identify the first obstacle more accurately. Incidentally, the first threshold value, and the second threshold value are preset by a system administrator or the like.

Here, the vicinity of the UAV 1 may be, for example, within a predetermined range based on the current position of the UAV 1 (e.g., within a radius of 500 m centered on the current position of the UAV 1). In the process for identifying the first obstacle, the obstacle identification unit 162 may acquire feature information including, for example, horizontal position (e.g., latitude and longitude) and height (i.e., value indicating height) of one or more ground features present in the vicinity of the UAV 1 in flight from the flight management server 2, and identify the first obstacle based on the feature information. For example, the obstacle identification unit 162 identifies the height of one or more ground features from the acquired feature information, and identifies, as the first obstacle, one or more ground features whose the identified height is greater than or equal to a predetermined height (e.g., 20 m). This makes it possible to identify the first obstacle more appropriately. Alternatively, the obstacle identification unit 162 identifies the horizontal position and the height of one or more ground features from the acquired feature information, and identifies, as the first obstacle, one or more ground features whose “the distance from the current position of the UAV 1 to the identified horizontal position is within a predetermined distance (e.g., within 50 m)” and “the identified height is greater than or equal to a predetermined height”. Moreover, the obstacle identification unit 162 may acquire map data around the UAV 1 in flight from the flight management server 2, and acquire the feature information from the map data. This makes it possible to identify the first obstacle more efficiently.

The flight control unit 163 performs flight control (including take-off control and landing control) of the UAV 1 by using the current position detected by the positioning unit 12, sensing information acquired from the sensor unit 14, flight control information, and the like. In the flight control, the rotation speed (the number of rotations) of the rotor 1a, the position, attitude, and traveling direction of the UAV 1 are controlled. The flight control information is acquired, for example, from the flight management server 2. The flight control information includes, for example, a predetermined flight route from a departure point to a destination point (e.g., a delivery destination of an article) and flight schedule. The flight route may be expressed, for example, by the latitude and longitude of each of a plurality of waypoints (an example of a predetermined point) on the flight route, or may be expressed by the latitude, longitude, and altitude of each of the waypoints. The flight schedule may include, for example, a scheduled departure time for UAV 1 to depart from the departure point and a scheduled arrival time when the UAV 1 arrives at the destination point. Moreover, the flight schedule may include a scheduled passing time when the UAV 1 passes through each waypoint.

Furthermore, the flight control unit 163 performs the flight control of the UAV 1 in flight such that the UAV 1 moves away from the first obstacle identified by the obstacle identification unit 162. For example, the flight control unit 163 moves the UAV 1 to a direction in which the reduction of the positioning accuracy will be recovered (in other words, the positioning accuracy will be restored). That is, the UAV 1 flies to a direction for recovering the reduced positioning accuracy. Here, the “direction in which the reduction of the positioning accuracy will be recovered” is, for example, a direction in which the capture number of the positioning satellites is greater than or equal to the first threshold value, or a direction in which the DOP is less than or equal to the second threshold value. Such direction may be a horizontal direction, but preferably a direction in which the UAV 1 ascends (i.e., to raise the altitude of the UAV 1) at a predetermined ascent angle θ (0 degrees<θ≤90 degrees).

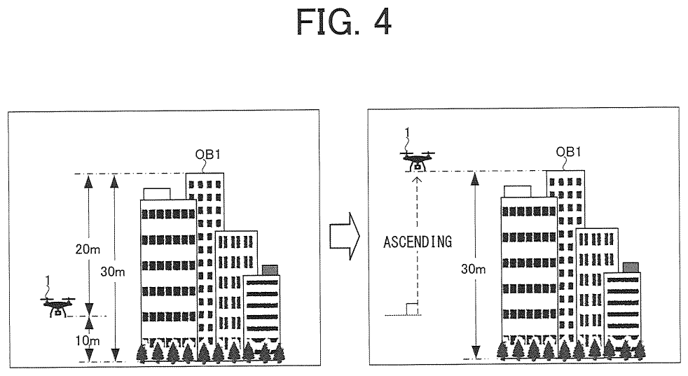

For example, the flight control unit 163 may perform, in response to that a value obtained (calculated) by subtracting the current altitude of the UAV 1 from the height (e.g., the maximum value) of the identified first obstacle is greater than or equal to 0 and the obtained value is less than or equal to a third threshold value, the flight control of the UAV 1 such that the UAV 1 vertically ascends. Here, the current altitude of the UAV 1 may be a value indicating the interpolated height as described above. FIG. 4 is a conceptual diagram illustrating the UAV 1 ascending vertically (θ=90 degrees). In the example of FIG. 4, the value (e.g., 20 m) obtained by subtracting the current altitude (e.g., 10 m) of the UAV 1 from the height (e.g., 30 m) of the obstacle OB1 is greater than 0 m and less than the third threshold (e.g., 30 m). Thus, the flight control unit 163 performs the flight control of the UAV 1 such that the UAV 1 ascends to the vertical direction (θ=90 degrees). At this tame, the flight control unit 163 may control the UAV 1 so as to ascend at a predetermined ascent speed (e.g., 4 m/s). This makes it possible to more quickly recover from the reduction of the positioning accuracy. In the example of FIG. 4, the UAV 1 exits (escapes) from the obstacle OB1 by ascending 20 m. That is, the UAV 1 ascends to locate at a height greater than or equal to the height of the obstacle OB1. At this time, the flight control unit 163 may determine how high (in other words, how far) to ascend the UAV 1 based on the current altitude of the UAV 1 and the height of the obstacle OB1.

Alternatively, the flight control unit 163 may perform, in response to that the height of the identified first obstacle is less than or equal to the third threshold value (e.g., 40 m), the flight control of the UAV 1 such that the UAV 1 vertically ascends. This also makes it possible to more quickly recover from the reduction of the positioning accuracy. In this case, in the example of FIG. 4, since the height (e.g., 30 m) of the obstacle OB1 is less than the third threshold (e.g., 40 m), the UAV 1 is controlled to fly upward in a vertical direction. Incidentally, the flight control unit 163 may perform, in response to that the height of the obstacle OB1 is less than or equal to the third threshold, the flight control of the UAV 1 such that the UAV 1 ascends at a predetermined ascent angle on the flight route (a two-dimensional route excluding height). As a result, since the altitude only is changed on the flight route, for example, when there is only one obstacle, the UAV 1 can fly while passing (eluding) through the obstacle. Thus, it can be expected to recover from the reduction of the positioning accuracy faster than vertically ascending.

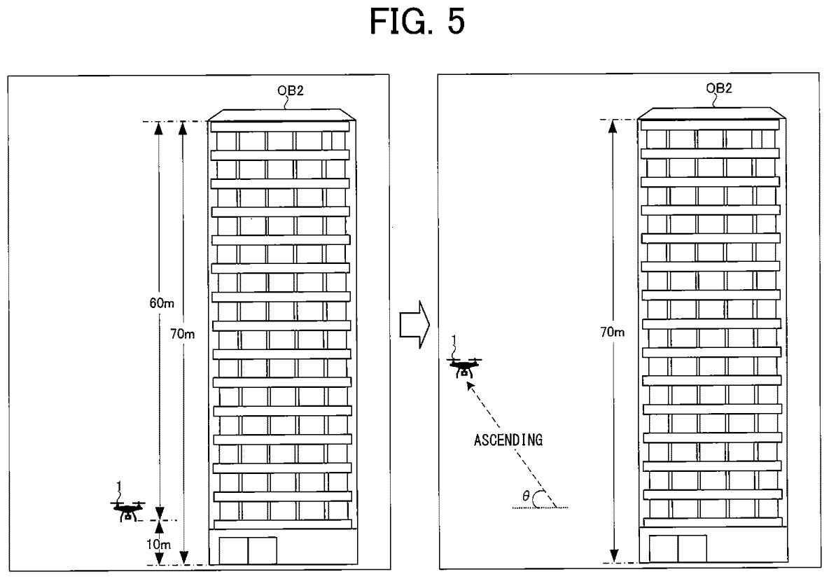

On the other hand, the flight control unit 163 may perform, in response to that a value obtained by subtracting the current altitude of the UAV 1 from the height of the identified first obstacle is greater than the third threshold value (e.g., 30 m), the flight control of the UAV 1 such that the UAV 1 moves horizontally away from the first obstacle while ascending. For example, the UAV 1 ascends to an oblique upward direction. FIG. 5 is a conceptual diagram illustrating the UAV 1 ascending to an oblique upward direction (0 degrees<θ<90 degrees). In the example of FIG. 5, the value (e.g., 60 m) obtained by subtracting the current altitude (e.g., 10 m) of the UAV 1 from the height (e.g., 70 m) of the obstacle OB2 is greater than the third threshold (e.g., 30 m). Thus, the flight control unit 163 performs the flight control of the UAV 1 such that the UAV 1 moves horizontally away from the obstacle OB2 while ascending. As a result, even if the obstacle OB2 that prevents the reception of radio waves from the positioning satellites is relatively higher, it is possible to more quickly recover from the reduction of the positioning accuracy. Incidentally, in the example of FIG. 5, in a case where the altitude of the UAV 1 is 50 m, since the value (e.g., 20 m) obtained by subtracting the current altitude of the UAV 1 from the height of the identified obstacle (e.g., 70 m) is less than the third threshold (e.g., 30 m), the flight control is performed so that UAV 1 ascends vertically.

Alternatively, the flight control unit 163 may perform, in response to that the height of the identified first obstacle is greater than the third threshold value (e.g., 40 m), the flight control of the UAV 1 such that the UAV 1 moves horizontally away from the first obstacle while ascending. This also makes it possible to more quickly recover from the reduction of the positioning accuracy. In this case, in the example of FIG. 5, since the height (e.g., 70 m) of the obstacle OB2 is greater than the third threshold (e.g., 40 m), the UAV 1 is controlled to move horizontally away from the obstacle OB2 while ascending.

Moreover, as described above, in a case where UAV 1 ascends and moves horizontally away from the identified first obstacle, the flight control unit 163 may determine whether there is a second obstacle (i.e., another obstacle) in a direction away from the identified first obstacle. Then, when it is determined that there is the second obstacle in the direction away from the identified first obstacle, that is, in response to detecting the second obstacle present in the direction away from the first obstacle, the flight control unit 163 may calculate an ascent angle at which the UAV 1 does not collide with the second obstacle, and perform the flight control of the UAV 1 such that the UAV 1 ascends at the calculated ascent angle. This makes it possible to more safely recover from the reduction of the positioning accuracy.

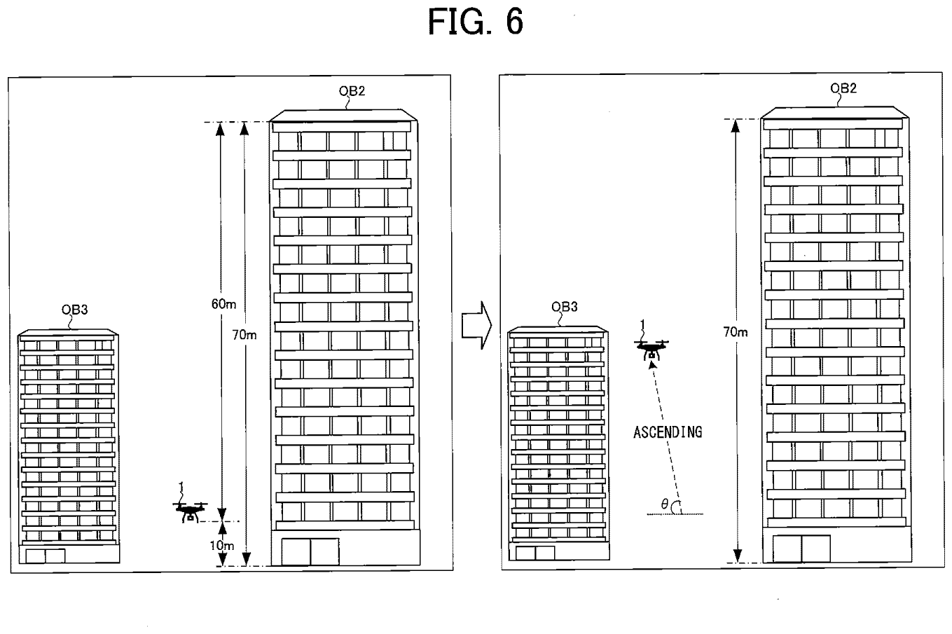

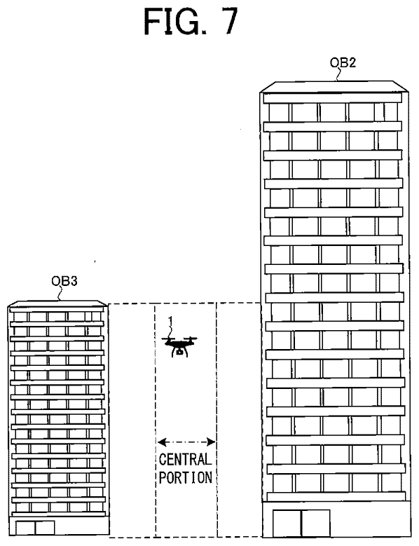

FIG. 6 is a conceptual diagram illustrating the UAV 1 ascending at an ascent angle that will not collide with the obstacle OB3 located on the opposite side of the obstacle OB2. Alternatively, when it is determined that there is the second obstacle in the direction away from the identified first obstacle, that is, in response to detecting the second obstacle present in the direction away from the first obstacle, the flight control unit 163 may perform the flight control of the UAV 1 such that the UAV 1 ascends through a central portion between the first obstacle and the second obstacle. This also makes it possible to more safely recover from the reduction of the positioning accuracy. FIG. 7 is a conceptual diagram illustrating an example of the central portion between the obstacle OB2 and the obstacle OB3. Here, in case where the area between the obstacle OB2 and the obstacle OB3 is divided into an area close to the obstacle OB2, an area close to the obstacle OB3, and a central area, the central area corresponds to the central portion. The central portion may change depending on the distance between the obstacle OB2 and the obstacle OB3.

Moreover, when the reduction of the positioning accuracy according to the UAV 1 ascending in accordance with the flight control is recovered (in other words, the positioning accuracy is restored), the flight control unit 163 preferably performs the flight control of the UAV 1 such that the UAV 1 gradually descends to a next waypoint (an example of a predetermined point) to aim for which the UAV 1 should be directed. For example, the flight control unit 163 preferably perform, in response to that the capture number of the positioning satellites is greater than or equal to the first threshold value due to the UAV 1 ascending in accordance with the flight control, the flight control of the UAV 1 such that UAV 1 gradually descends to the next waypoint. Alternatively, the flight control unit 163 preferably perform, in response to that the DOP is less than or equal to the second threshold value due to the UAV 1 ascending in accordance with the flight control, the flight control of the UAV 1 such that UAV 1 gradually descends to the next waypoint. This allows the UAV 1 to more safely return to its original flight route before ascent.

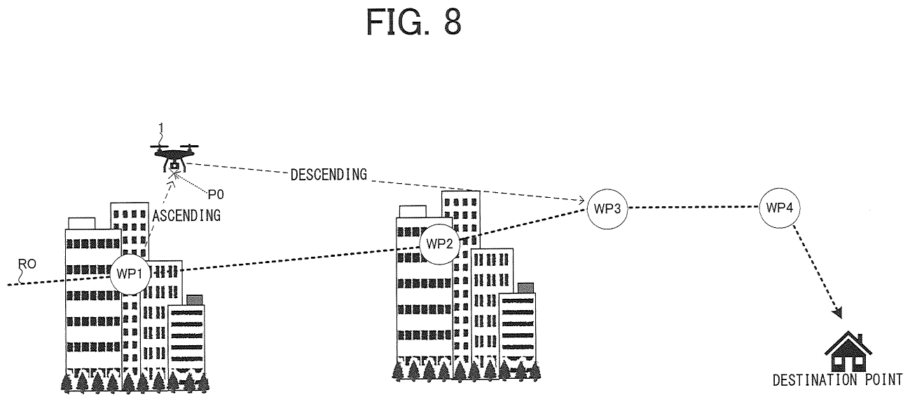

FIG. 8 is a conceptual diagram illustrating the UAV 1 gradually descending to the waypoint WP3 after the reduction of the positioning accuracy is recovered. In the example of FIG. 8, the flight route RO passing through the waypoints WP1 to WP4 is a preset flight route. FIG. 8 shows that the reduction of the positioning accuracy has occurred at the waypoint WP1. As illustrated in FIG. 8, when the UAV 1 temporarily deviates from the flight route RO by ascending, and then the reduction of the positioning accuracy is recovered at the point P0, the UAV 1 gradually descends to the next desired waypoint WP3 to aim for (i.e., to be targeted). And then, once the UAV 1 reaches waypoint WP3, the UAV 1 returns to the flight route RO. Incidentally, in the example of FIG. 8, the UAV 1 flies towards the waypoint WP3 instead of the waypoint WP2 in order to gradually descend. That is, in this case, the flight control unit 163 determines the next waypoint WP3 to aim for based on a predetermined descent angle (lowering angle)for the gradual descent.

Alternatively, the flight control unit 163 may identify a waypoint where the reduction of the positioning accuracy is forecasted to be recovered among waypoints to be passed (i.e., waypoints that is scheduled to pass) on the flight route of the UAV 1, and perform the flight control of the UAV 1 toward the identified waypoint while avoiding the identified first obstacle. This makes it possible for the UAV 1 to return to more quickly the original flight route. Thus, it is possible to more quickly recover from the reduction of the positioning accuracy. For example, the flight control unit 163 acquires, from the flight management server 2, a forecasted capture number of the positioning satellites that can be captured at each of the waypoints to be passed on the flight route. And then, the flight control unit 163 identifies, as the waypoint where the reduction of the positioning accuracy is forecasted to be recovered, a waypoint where the acquired forecasted capture number is greater than or equal to the first threshold value (e.g., 4). This makes it possible to more accurately identify a waypoint where the positioning accuracy is expected to be restored. Alternatively, the flight control unit 163 may acquire, from the flight management server 2, a forecasted DOP at each of the waypoints to be passed on the flight route. And then, the flight control unit 163 may identify, as the waypoint where the reduction of the positioning accuracy is forecasted to be recovered, a waypoint where the acquired forecasted DOP is less than or equal to the second threshold value (e.g., 4). This also makes it possible to more accurately identify a waypoint where the positioning accuracy is expected to be restored.

Alternatively, the flight control unit 163 may set a fourth threshold value (e.g., 5) greater than the first threshold value (e.g., 4), and identify, as the waypoint where the reduction of the positioning accuracy is forecasted to be recovered, a waypoint where the acquired forecasted capture number is greater than or equal to the fourth threshold value. This makes it possible to more safely recover from the reduction of the positioning accuracy even if a point at which the situation of indicating the reduction of the positioning accuracy has occurred, is just before a next waypoint to be reached (i.e., even when the distance between the point at which the situation has occurred and the next waypoint is short, such as a few meters). Alternatively, the flight control unit 163 may set a fifth threshold value (e.g., 3) less than the second threshold value (e.g., 4), and to identify, as the waypoint where the reduction of the positioning accuracy is forecasted to be recovered, a waypoint where the acquired DOP is less than or equal to the fifth threshold value. This also makes it possible to more safely recover from the reduction of the positioning accuracy even if a point at which the situation of indicating the reduction of the positioning accuracy has occurred, is just before a next waypoint to be reached. Incidentally, the fourth or fifth threshold value may be set when the remaining battery charge of UAV 1 is greater than a battery amount required to reach the destination point.

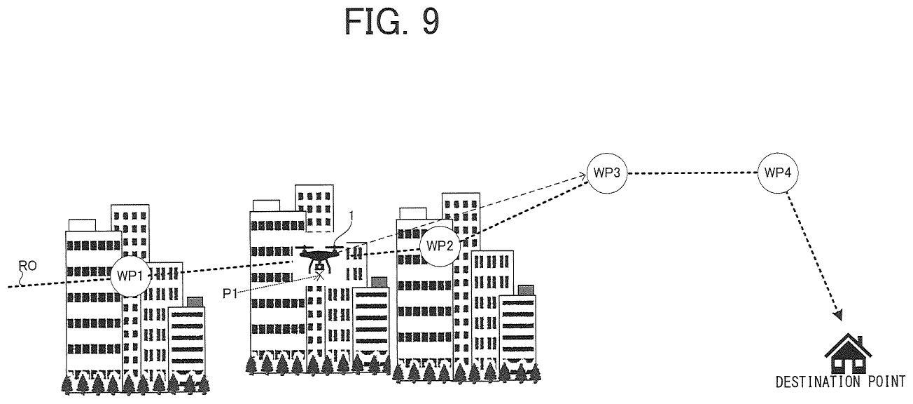

FIG. 9 is a conceptual diagram illustrating the UAV 1 flying toward the waypoint WP3 where the reduction of the positioning accuracy is forecasted to be recovered. FIG. 9 shows that UAV 1 skips the waypoint WP2 and heads to the identified waypoint WP3 because the capture number of positioning satellites falls below the first threshold value at the point P1 on the way to the waypoint WP2. Here, the waypoint WP3 may be, for example, a waypoint where the forecasted capture number is greater than or equal to the fourth threshold value that is greater than the first threshold value, or a waypoint where the forecasted DOP is greater than or equal to the fifth threshold value that is less than the second threshold value.

### 1-2. Configuration and Function of Flight Management Server 2

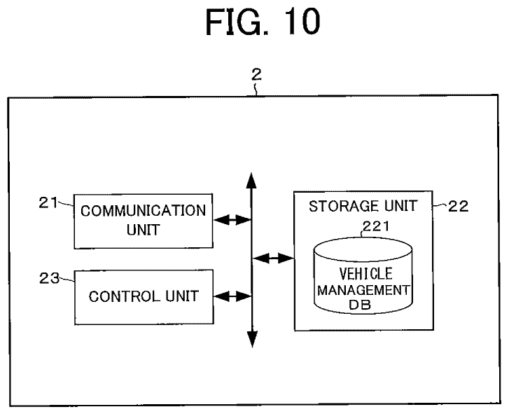

Next, a configuration and a function of the flight management server 2 will be described with reference to FIG. 10. FIG. 10 is a diagram illustrating a schematic configuration example of the flight management server 2. As illustrated in FIG. 10, the flight management server 2 includes a communication unit 21, a storage unit 22, a control unit 23, and the like. The communication unit 21 controls communication performed via the communication network NW. Thereby, the flight management server 2 can communicate with the UAV 1. The position information transmitted from the UAV 1 is received by the communication unit 21. Thereby, the flight management server 2 can recognize the current position of the UAV 1. Furthermore, the flight management server 2 can communicate via the communication network NW with a satellite orbit management server (not shown) that manages the respective orbits (trajectory) of the plurality of positioning satellites moving around the earth. Thereby, the flight management server 2 receives orbit information indicating the respective orbits of the plurality of positioning satellites from the satellite orbit management server. The orbit information indicates the satellite position and time on the respective orbits of the positioning satellites. The satellite position and time are forecasted (predicted), for example, 24 to 48 hours in advance. The satellite position is a position of the satellite at a future time, and is expressed, for example, by latitude, longitude, and altitude.

The storage unit 22 includes, for example, a hard disk drive (HDD), and stores various programs including an operating system (OS), an application program, and the like. Moreover, the storage unit 22 stores map data of a flight area of the UAV 1. The map data includes information showing a horizontal position, height, and size (area) of artifacts such as buildings installed within the flight area. Incidentally, the map data may include information showing a position, height, and size of a natural object (material) such as a tree, mountain, or hill that exists within the flight area. Furthermore, in the storage unit 22, a vehicle management database (DB) 221, and the like are constructed. The vehicle management database 221 is a database for managing information on the UAV 1. In the vehicle management database 221, for example, the vehicle ID, the flight route, the flight schedule, and the like are stored in association with each UAV 1.

The control unit 23 includes at least one CPU, a ROM, a RAM, and the like. The control unit 23 transmits the flight control information including the flight route and flight schedule to the UAV 1 via the communication unit 21. Moreover, the control unit 23 transmits, to the UAV 1 via the communication unit 21, the map data or the feature information including horizontal position and height of one or more ground features present in the vicinity of the current position of the UAV 1. Moreover, the control unit 23 calculates the forecasted capture number of the positioning satellites that can be captured at each of the plurality of the waypoints on the flight route, on the basis of the position (e.g., three-dimensional coordinates) of each waypoint and the orbit information acquired from the satellite orbit management server (e.g., the satellite position at the time of passing each waypoint), etc. Moreover, the control unit 23 may calculate the forecasted DOP at each of the plurality of the waypoints on the flight route, on the basis of the position of each waypoint and the orbit information acquired from the satellite orbit management server. Then, the control unit 23 may transmit satellite information indicating the forecasted capture number of the positioning satellites that can be captured at each waypoint (or the forecasted DOP at each waypoint) to the UAV 1 via the communication unit 21. Incidentally, the control unit 23 may cooperate with the control unit 16 of the UAV 1 to perform the flight control of the UAV 1. In this case, the control unit 23 transmits a flight control command for controlling the traveling direction of the UAV 1 to the UAV 1 via the communication unit 21.

### 2. Operation of Flight Control System S

Next, an operation of the flight control system S according to this embodiment will be described in Example 1 and Example 2.

### Example 1

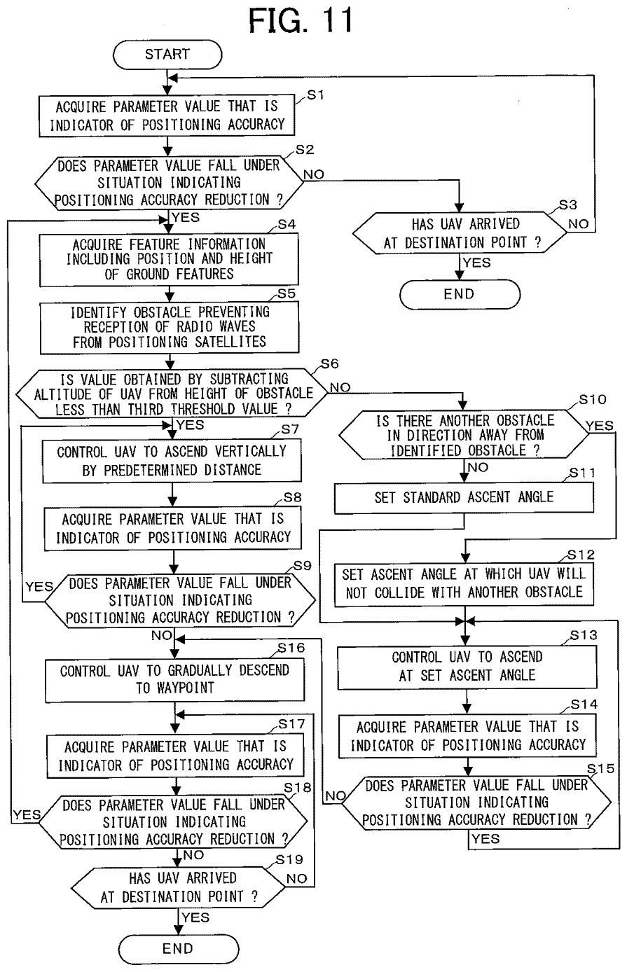

First, the operation of the delivery system S according to Example 1 will be described with reference to FIG. 11. FIG. 11 is a flowchart illustrating an example of a flight control processing executed by the control unit 23 of the flight management server 2 in Example 1. The processing illustrated in FIG. 11 is started, for example, when the UAV 1 starts flying from the departure point. Incidentally, when the UAV starts flying, it basically flies by following each waypoint on the flight route. When the processing illustrated in FIG. 11 is started, the control unit 16 acquires, by the satellite information acquisition unit 161, the parameter value (e.g., the capture number of positioning satellites or the DOP) that is the indicator of the positioning accuracy on the basis of information on radio waves from the positioning satellites captured by the positioning unit 12 (step S1).

Next, the control unit 16 determines whether the parameter value acquired in step S1 falls under a situation that indicates the reduction of the positioning accuracy (step S2). For example, the obstacle identification unit 162 compares the capture number acquired in step S1 with the first threshold value, and determines whether the capture number is less than the first threshold value. Alternatively, the obstacle identification unit 162 compares the DOP acquired in step S1 with the second threshold value, and determines whether the DOP is greater than the second threshold value. When it is determined that the parameter value does not fall under the situation that indicates the reduction of the positioning accuracy (e.g., the capture number is not less than the first threshold value, or the DOP is not greater than the second threshold value) (step S2: NO), the process proceeds to step S3. On the other hand, when it is determined that the parameter value falls under the situation that indicates the reduction of the positioning accuracy (e.g., the capture number is less than the first threshold value, or the DOP is greater than the second threshold value) (step S2: YES), the process proceeds to step S4.

Incidentally, in step S2, instead of comparing the capture number with the first threshold value, the obstacle identification unit 162 may determine whether a value obtained by subtracting the capture number acquired in the current step S1 (e.g., 4) from the capture number acquired in the previous step S1 (e.g., 5) is greater than or equal to a threshold value (a positive (plus) value, e.g., 1), and when the value is greater than or equal to the threshold value (i.e., when the capture number has decreased), the process may proceed to step S4. Alternatively, in step S2, instead of comparing the DOP with the second threshold value, the obstacle identification unit 162 may determine whether a value obtained by subtracting the DOP (e.g., 3) acquired in the previous step S1 from the DOP (e.g., 4) acquired in the current step S1 is greater than or equal to a threshold value (a positive value: e.g., 1), and when the value is greater than or equal to the threshold value (i.e., when the DOP has increased), the process may proceed to step S4.

In step S3, the control unit 16 determines whether the UAV 1 has arrived at the destination point. When it is determined that the UAV 1 has not arrived at the destination point (step S3: NO), the process returns to step S1. On the other hand, when it is determined that the UAV 1 has arrived at the destination point (step S3: YES), the processing illustrated in FIG. 11 ends. After the processing illustrated in FIG. 11 ends, the UAV 1 lands according to a landing control by the control unit 16. Alternatively, the UAV 1 drops an article while hovering according to a hovering control by the control unit 16.

In step S4, the control unit 16 acquires the feature information including the horizontal position and the height of the ground features present in the vicinity of the flying UAV 1. Here, the feature information may be acquired from the flight management server 2 (stored in the storage unit 15) before the start of the processing illustrated in FIG. 11, or may be acquired by making a request to the flight management server 2 in step S4. Incidentally, that map data including the feature information may be acquired. Next, based on the feature information acquired in step S4, the control unit 16 identifies, by the obstacle identification unit 162, the obstacle (i.e., the first obstacle present in the vicinity of the UAV 1) that prevents the reception of radio waves from the positioning satellites (step S5). At this time, the horizontal position and the height of the obstacle may be identified. Incidentally, a plurality of the obstacles may be identified in step S5. In this case, the plurality of the obstacles may be treated as a unit in the following process.

Next, the control unit 16 acquires the current altitude (e.g., a value indicating the interpolated height) of the UAV 1 from the positioning unit 12, and determines whether the value obtained by subtracting the current altitude of UAV 1 from the height (e.g., the maximum value) of the obstacle (i.e., first obstacle) identified in step S5 is less than or equal to the third threshold value (step S6). When it is determined that the value obtained by subtracting the current altitude of the UAV 1 from the height of the obstacle is less than or equal to the third threshold value (step S6: YES), the process proceeds to step S7. On the other hand, when it is determined that the value obtained by subtracting the current altitude of the UAV 1 from the height of the obstacle is not less than or equal to the third threshold value (step S6: NO), the process proceeds to step S10. Incidentally, even if it is determined that the value obtained by subtracting the current altitude of UAV 1 from the height of the obstacle is not less than or equal to the third threshold value, the process may proceed to step S7 if the distance between the horizontal position of the UAV 1 and the horizontal position of the obstacle is greater than a predetermined distance (e.g., 20 m).

As another example of step S6, it may be determined whether the height (for example, the maximum value) of the obstacle identified in step S5 is less than or equal to the third threshold value. Then, when it is determined that the height of the obstacle is less than or equal to the third threshold value (step S6: YES), the process proceeds to step S7. On the other hand, when it is determined that the height of the obstacle is not less than or equal to the third threshold value (step S6: NO), the process proceeds to step S10. Incidentally, even if the height of the obstacle is greater than (i.e., not less than or equal to) the third threshold value, the process may proceed to step S7 if the distance between the horizontal position of the UAV 1 and the horizontal position of the obstacle is greater than a predetermined distance (e.g., 20 m).

In step S7, the control unit 16 performs the flight control of the UAV 1 such that the UAV 1 ascends vertically by a predetermined distance (e.g., 5 m). Next, the control unit 16 acquires the parameter value as the indicator of the positioning accuracy on the basis of information of the radio waves from the positioning satellites captured by the positioning unit 12 (step S8), similar to step S1. Next, the control unit 16 determines whether the parameter value acquired in step S8 falls under a situation that indicates the reduction of the positioning accuracy (step S9). When it is determined that the parameter value does not fall under the situation that indicates the reduction of the positioning accuracy (i.e., the positioning accuracy has been restored) (step S9: NO), the process proceeds to step S16. On the other hand, when it is determined that the parameter value falls under the situation that indicates the reduction of the positioning accuracy (step S9: YES), the process returns to step S7.

Incidentally, in step S7, the control unit 16 may perform the flight control of the UAV 1 so as to ascend by a distance (e.g., a distance to the position corresponding to the height of the obstacle) corresponding to the height (e.g., the interpolated height) of the obstacle minus the current altitude of the UAV 1. In this case, the control unit 16 may skip the process of steps S8 and S9, and move to step S16.

In step S10, the control unit 16 determines whether there is another obstacle (i.e., second obstacle) in a direction away from the obstacle identified in step S5. When it is determined that there is not the other obstacle (step S10: NO), the standard ascent angle is set (step S11), and the process proceeds to step S13. On the other hand, when it is determined that there is the other obstacle (step S10: YES), the process proceeds to step S12. In step S12, the control unit 16 calculates and sets an ascent angle at which the UAV 1 will not collide with the other obstacle, and then proceeds to step S13. For example, based on the horizontal position of UAV 1 and the horizontal position and height of the other obstacle, the ascent angle at which UAV 1 will not collide with the other obstacle is calculated.

In step S13, the control unit 16 performs the flight control of the UAV 1 such that the UAV 1 ascends by a predetermined distance at the ascent angle set in step S11 or step S12. Next, the control unit 16 acquires the parameter value that is the indicator of the positioning accuracy based on information of the radio waves from the positioning satellites captured by the positioning unit 12 (step S14), similar to step S1. Next, the control unit 16 determines whether the parameter value acquired in step S14 falls under a situation that indicates the reduction of the positioning accuracy (step S15). When it is determined that the parameter value does not fall under the situation that indicates the reduction of the positioning accuracy (i.e., the reduction of the positioning accuracy has recovered) (step S15: NO), the process proceeds to step S16. On the other hand, when it is determined that the parameter value falls under the situation that indicates the reduction of the positioning accuracy (step S15: YES), the process returns to step S13.

In step S16, the control unit 16 performs the flight control of the UAV 1 such that UAV 1 gradually descends to the next waypoint to aim for. Incidentally, when UAV 1 reaches the next waypoint (i.e., when it returns to the original flight route), the flight of UAV 1 is controlled such that the UAV 1 flies along each waypoint on the flight route. Next, similarly to step S1, the control unit 16 acquires the parameter value that is the indicator of the positioning accuracy based on information of the radio waves from the positioning satellites captured by the positioning unit 12 (step S17). Next, the control unit 16 determines whether the parameter value acquired in step S17 falls under a situation that indicates the reduction of the positioning accuracy (step S18).

When it is determined that the parameter value falls under the situation that indicates the reduction of the positioning accuracy (e.g., the capture number is less than the first threshold value, or the DOP is greater than the second threshold value) (step S18: YES), the process returns to step S4, and the same process as above is executed. On the other hand, when it is determined that the parameter value does not fall under the situation that indicates the reduction of the positioning accuracy (e.g., the capture number is not less than the first threshold value, or the DOP is not greater than the second threshold value) (step S18: NO), it is determined whether UAV 1 has arrived at the destination point (step S19). When it is determined that the UAV 1 has not arrived at the destination point (step S19: NO), the process returns to step S17, and the processes of steps S17 and S18 are executed. On the other hand, when it is determined that the UAV 1 has arrived at the destination point (step S19: YES), the processing illustrated in FIG. 11 ends.

### Example 2

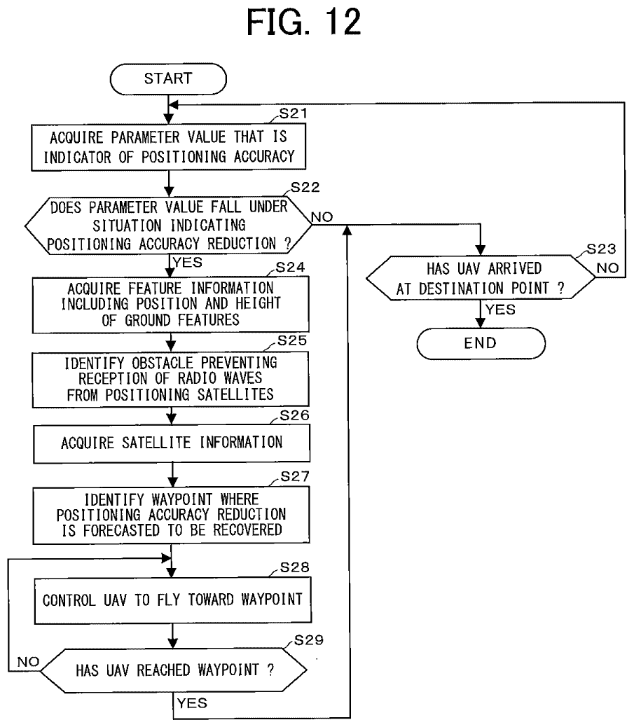

Next, the operation of the delivery system S according to Example 2 will be described with reference to FIG. 12. FIG. 12 is a flowchart illustrating an example of a flight control processing executed by the control unit 23 of the flight management server 2 in Example 2. The processing illustrated in FIG. 12 is started, for example, when the UAV 1 starts flying from the departure point. Incidentally, when the UAV starts flying, it basically flies by following each waypoint on the flight route. When the processing illustrated in FIG. 12 is started, the control unit 16 acquires, by the satellite information acquisition unit 161, the parameter value (e.g., the capture number of positioning satellites or the DOP) that is the indicator of the positioning accuracy on the basis of information on the radio waves from the positioning satellites captured by the positioning unit 12 (step S21).

Next, the control unit 16 determines whether the parameter value acquired in step S21 falls under a situation that indicates the reduction of the positioning accuracy (step S22). When it is determined that the parameter value does not fall under the situation that indicates the reduction of the positioning accuracy (e.g., the capture number is not less than the first threshold value, or the DOP is not greater than the second threshold value) (step S22: NO), the process proceeds to step S23. On the other hand, when it is determined that the parameter value falls under the situation that indicates the reduction of the positioning accuracy (e.g., the capture number is less than the first threshold value, or the DOP is greater than the second threshold value) (step S22: YES), the process proceeds to step S24. Incidentally, in step S22, similarly to step S2, it may be determined whether the value obtained by subtracting the capture number acquired in the current step S21 from the capture number acquired in the previous step S21 is greater than or equal to the threshold value. Alternatively, it may be determined whether the value obtained by subtracting the DOP acquired in the previous step S21 from the DOP acquired in the current step S21 is greater than or equal to the threshold value.

In step S23, the control unit 16 determines whether the UAV 1 has arrived at the destination point. When it is determined that the UAV 1 has not arrived at the destination point (step S23: NO), the process returns to step S21. On the other hand, when it is determined that the UAV 1 has arrived at the destination point (step S23: YES), the processing illustrated in FIG. 12 ends. In step S24, similar to step S4, the feature information including the horizontal position and the height of the ground features present in the vicinity of the flying UAV 1, is acquired. Next, similar to step S5, based on the feature information acquired in step S24, the obstacle that prevents the reception of the radio waves from the positioning satellites is identified in the vicinity of the UAV 1 (step S25), and the process proceeds to step S26.

In step S26, the control unit 16 acquires, from the flight management server 2, the satellite information indicating the forecasted capture number of the positioning satellites that can be captured at each of the waypoints to be passed on the flight route, or the forecasted DOP at each of the waypoints to be passed on the flight route. Here, the feature information may be acquired from the flight management server 2 (stored in the storage unit 15) before the start of the processing illustrated in FIG. 12, or may be acquired by making a request to the flight management server 2 in step S26. Incidentally, the control unit 16 may acquire the orbit information (e.g., satellite positions at the time of passing each waypoint) from the flight management server 2 or the satellite orbit management server. In this case, the control unit 16 calculates the forecasted capture number of the positioning satellites or the forecasted DOP based on the positions of each waypoint, the acquired orbit information, and the like.

Next, based on the satellite information acquired in step S26, the control unit 16 identifies, as the waypoint where the reduction of the positioning accuracy is forecasted to be recovered, a waypoint where the forecasted capture number of positioning satellites is greater than or equal to the first threshold value, or where the forecasted DOP is less than or equal to the second threshold value (step S27). Incidentally, before the process of step S27, a fourth threshold value larger than the first threshold value or a fifth threshold value smaller than the second threshold value may be set. In this case, in step S27, based on the acquired satellite information, a waypoint where the forecasted capture number of positioning satellites is greater than or equal to the fourth threshold value, or a waypoint where the forecasted DOP is less than or equal to the fifth threshold value is identified as the waypoint where the reduction of the positioning accuracy is forecasted to be recovered.

Next, the control unit 16 performs the flight control of the UAV 1 toward the waypoint identified in step S27 (step S28). Next, the control unit 16 determines whether the UAV 1 has reached the waypoint identified in step S27 (step S29). When it is determined that the UAV 1 has not been reached the waypoint (step S29: NO), the process returns to step S28. On the other hand, when it is determined that the UAV 1 has reached the waypoint (step S29: YES), the process proceeds to step S23.

As described above, according to the embodiment, the UAV 1 sequentially acquires, as satellite information relating to one or more positioning satellites, a parameter value that is the indicator of the positioning accuracy on the basis of information on radio waves from the captured positioning satellites while the UAV 1 is flying, identifies a first obstacle that prevents reception of the radio waves in a vicinity of the UAV 1 in flight in response to that the parameter value falls under the situation indicating the reduction of the positioning accuracy, and flies so as to move away from the identified first obstacle. Therefore, flight control of the UAV 1 can be performed safely even in a place with many obstacles that prevent the reception of the radio waves from the positioning satellites. Namely, it is possible to prevent unexpected incidents and delays in the delivery of the article caused by the UAV 1 flying in an unexpected direction or stopping on the spot, due to an inability to adequately capture the positioning satellites. Especially, in an urban area where buildings (e.g., high-rise buildings) are crowded together (e.g., densely packed), even if the positioning satellites cannot be adequately captured, the above embodiment can more effectively prevent the unexpected incidents and the delays in the delivery of the article.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above embodiment, the capture number of positioning satellites and the DOP are taken as examples of the parameter value. However, as another example, a radio wave intensity from the positioning satellites may be applied. In this case, the obstacle identification unit 162 sequentially compares the radio wave intensities acquired sequentially by the satellite information acquisition unit 161 with a sixth threshold value (e.g., 40 dB/Hz), and identifies the first obstacle preventing the reception of the radio waves in the vicinity of the UAV 1 when the radio wave intensity is less than the sixth threshold value as falling under the situation indicating the reduction of the positioning accuracy.

Moreover, in the above embodiment, the control unit 16 of the UAV 1 is configured to sequentially acquire the parameter value that is the indicator of the positioning accuracy, to identify the first obstacle that prevents the reception of the radio waves in the vicinity of the UAV 1 when the parameter value falls under the situation indicating the reduction of the positioning accuracy, and to perform the flight control of the UAV 1 so as to move away from the identified first obstacle. However, such processing (for example, the processing illustrated in FIGS. 11 and 12) may be executed by the control unit 23 of the flight management server 2. In this case, the control unit 23 sequentially acquires information on the radio waves from the positioning satellites captured by the positioning unit 12 while the UAV 1 is flying, sequentially acquires the parameter value that is the indicator of the positioning accuracy based on the acquired information on the radio waves. Then, the control unit 23 identifies the first obstacle that prevents the reception of the radio waves in the vicinity of the UAV 1 in flight when the parameter value falls under the situation indicating the reduction of the positioning accuracy (e.g., the capture number is less than the first threshold value, or the DOP is greater than the second threshold value), and performs the flight control of the UAV 1 so as to move away from the identified first obstacle. In such flight control, the control unit 23 transmits flight control commands to the UAV 1 to control the travel direction of the UAV 1.

### Note

[1] A flight control device according to the present disclosure includes: an acquisition unit configured to sequentially acquire, as satellite information relating to one or more positioning satellites, a parameter value that is an indicator of positioning accuracy on the basis of information on radio waves from the positioning satellites captured by an unmanned aerial vehicle in flight; an identification unit configured to identify a first obstacle that prevents reception of the radio waves in a vicinity of the unmanned aerial vehicle in response to that the parameter value falls under a situation that indicates reduction of the positioning accuracy; and a flight control unit configured to perform flight control of the unmanned aerial vehicle so as to move away from the identified first obstacle. This makes it possible to safely perform the flight control of the unmanned aerial vehicle even in a place with many obstacles that prevent the reception of radio waves from the positioning satellites.
[2] In the flight control device described in [1] above, the identification unit may be configured to identify the first obstacle on the basis of height of a ground feature present in the vicinity of the unmanned aerial vehicle. This makes it possible to more appropriately identify the first obstacle.
[3] In the flight control device described in [2] above, the identification unit may be configured to identify the height of the ground feature from map data around the unmanned aerial vehicle, and to identify the first obstacle on the basis of the identified height. This makes it possible to more efficiently identify the first obstacle.
[4] In the flight control device described in any one of [1] to [3] above, the acquisition unit may be configured to sequentially acquire, as the parameter value, a capture number of the one or more positioning satellites, and the identification unit may be configured to sequentially compare the acquired capture numbers with a first threshold value, and to identify the first obstacle in response to that the acquired capture number is less than or equal to the first threshold value. This makes it possible to more accurately identify the first obstacle.
[5] In the flight control device described in any one of [1] to [3] above, the acquisition unit may be configured to sequentially acquire, as the parameter value, a reduction rate of the positioning accuracy, and the identification unit may be configured to sequentially compare the acquired reduction rates with a second threshold value, and to identify the first obstacle in response to that the acquired reduction rate is greater than the second threshold value. This makes it possible to more accurately identify the first obstacle.
[6] In the flight control device described in any one of [1] to [5] above, the flight control unit may be configured to perform, in response to that a value obtained by subtracting an altitude of the unmanned aerial vehicle from height of the first obstacle is greater than or equal to 0 and the obtained value is less than or equal to a third threshold value, the flight control of the unmanned aerial vehicle such that the unmanned aerial vehicle vertically ascends. This makes it possible to more quickly recover from the reduction of the positioning accuracy.
[7] In the flight control device described in any one of [1] to [5] above, the flight control unit may be configured to perform, in response to that a value obtained by subtracting an altitude of the unmanned aerial vehicle from height of the first obstacle is greater than or equal to 0 and the obtained value is greater than a third threshold value, the flight control of the unmanned aerial vehicle such that the unmanned aerial vehicle moves horizontally away from the first obstacle while ascending. This makes it possible to more quickly recover from the reduction of the positioning accuracy.
[8] In the flight control device described in any one of [1] to [5] above, the flight control unit may be configured to perform, in response to that height of the first obstacle is less than or equal to a third threshold value, the flight control of the unmanned aerial vehicle such that the unmanned aerial vehicle vertically ascends. This makes it possible to more quickly recover from the reduction of the positioning accuracy.
[9] In the flight control device described in any one of [1] to [5] above, the flight control unit may be configured to perform, in response to that height of the first obstacle is greater than a third threshold value, the flight control of the unmanned aerial vehicle such that the unmanned aerial vehicle moves horizontally away from the first obstacle while ascending. This makes it possible to more quickly recover from the reduction of the positioning accuracy.
[10] In the flight control device described in any one of [7] to [9] above, the flight control unit may be configured to calculate, in response to detecting a second obstacle present in a direction away from the first obstacle, an ascent angle at which the unmanned aerial vehicle does not collide with the second obstacle, and to perform the flight control of the unmanned aerial vehicle such that the unmanned aerial vehicle ascends at the calculated ascent angle. This makes it possible to more safely recover from the reduction of the positioning accuracy.
[11] In the flight control device described in any one of [7] to [9] above, the flight control unit may be configured to perform, in response to detecting a second obstacle present in a direction away from the first obstacle, the flight control of the unmanned aerial vehicle such that the unmanned aerial vehicle ascends through a central portion between the first obstacle and the second obstacle. This makes it possible to more safely recover from the reduction of the positioning accuracy.
[12] In the flight control device described in [4] above, the flight control unit may be configured to perform, in response to that the capture number is greater than or equal to the first threshold value due to the unmanned aerial vehicle ascending in accordance with the flight control, the flight control of the unmanned aerial vehicle such that the unmanned aerial vehicle gradually descends to a predetermined point. This allows the unmanned aerial vehicle to more safely return to the flight route before ascent.
[13] In the flight control device described in [5] above, the flight control unit may be configured to perform, in response to that the reduction rate is less than or equal to the second threshold value due to the unmanned aerial vehicle ascending in accordance with the flight control, the flight control of the unmanned aerial vehicle such that the unmanned aerial vehicle gradually descends to a predetermined point. This allows the unmanned aerial vehicle to more safely return to a flight route before ascent.
[14] In the flight control device described in [1] above, the flight control unit may be configured to identify a waypoint where the reduction of the positioning accuracy is forecasted to be recovered among waypoints to be passed on a flight route of the unmanned aerial vehicle, and to perform the flight control of the unmanned aerial vehicle toward the identified waypoint while avoiding the identified first obstacle. This makes it possible for the unmanned aerial vehicle to more quickly return to an original flight route. Thus, it is possible to more quickly recover from the reduction of the positioning accuracy.
[15] In the flight control device described in [14] above, the flight control unit may be configured to acquire a forecasted capture number of the positioning satellites that can be captured at each of the waypoints to be passed on the flight route, and to identify, as the waypoint where the reduction of the positioning accuracy is forecasted to be recovered, a waypoint where the acquired forecasted capture number is greater than or equal to a first threshold value. This makes it possible to more accurately identify a waypoint where the positioning accuracy is expected to be restored.
[16] In the flight control device described in [15] above, the flight control unit may be configured to set a fourth threshold value greater than the first threshold value, and to identify, as the waypoint where the reduction of the positioning accuracy is forecasted to be recovered, a waypoint where the acquired forecasted capture number is greater than or equal to the fourth threshold value. This makes it possible to more safely recover from the reduction of the positioning accuracy even if a point at which the situation of indicating the reduction of the positioning accuracy has occurred, is just before a next waypoint to be reached.
[17] In the flight control device described in [14] above, the flight control unit may be configured to acquire a forecasted reduction rate of the positioning accuracy at each of the waypoints to be passed on the flight route, and to identify, as the waypoint where the reduction of the positioning accuracy is forecasted to be recovered, a waypoint where the acquired forecasted reduction rate is less than or equal to a second threshold value. This makes it possible to more accurately identify a waypoint where the positioning accuracy is expected to be restored.
[18] In the flight control device described in [17] above, the flight control unit may be configured to set a fifth threshold value less than the second threshold value, and to identify, as the waypoint where the reduction of the positioning accuracy is forecasted to be recovered, a waypoint where the acquired forecasted reduction rate is less than or equal to the fifth threshold value. This makes it possible to more safely recover from the reduction of the positioning accuracy even if a point at which the situation of indicating the reduction of the positioning accuracy has occurred, is just before a next waypoint to be reached.
[19] A flight control method according to the present disclosure is executed by one or more computers, and the method includes: sequentially acquiring, as satellite information relating to one or more positioning satellites, a parameter value that is an indicator of positioning accuracy on the basis of information on radio waves from the positioning satellites captured by an unmanned aerial vehicle in flight; identifying a first obstacle that prevents reception of the radio waves in a vicinity of the unmanned aerial vehicle in response to that the parameter value falls under a situation that indicates reduction of the positioning accuracy; and performing flight control of the unmanned aerial vehicle so as to move away from the identified first obstacle.
[20] An unmanned aerial vehicle capable of autonomous flight according to the present disclosure includes: an acquisition unit configured to sequentially acquire, as satellite information relating to one or more positioning satellites, a parameter value that is an indicator of positioning accuracy on the basis of information on radio waves from the positioning satellites captured by an unmanned aerial vehicle in flight; an identification unit configured to identify a first obstacle that prevents reception of the radio waves in a vicinity of the unmanned aerial vehicle in response to that the parameter value falls under a situation that indicates reduction of the positioning accuracy; and a flight control unit configured to perform flight control of the unmanned aerial vehicle so as to move away from the identified first obstacle.

### Reference Signs List

1 UAV
2 Flight management server
11 Drive unit
12 Positioning unit
13 Communication unit
14 Sensor unit
15 Storage unit
16 Control unit
161 Satellite information acquisition unit
162 Obstacle identification unit
163 Flight control unit
21 Communication unit
22 Storage unit
23 Control unit
S Flight control system
NW Communication network

What is claimed is:

1. A flight control device comprising:
at least one memory configured to store program code; and at least one processor configured to access the program code and operate as instructed by the program code, the program code including:
acquisition code configured to cause the at least one processor to sequentially acquire, as satellite information relating to one or more positioning satellites, a parameter value that is an indicator of positioning accuracy on the basis of information on radio waves from the positioning satellites captured by an unmanned aerial vehicle in flight;
identification code configured to cause the at least one processor to identify a first obstacle that prevents reception of the radio waves in a vicinity of the unmanned aerial vehicle in response to that the parameter value falls under a situation that indicates reduction of the positioning accuracy; and
flight control code configured to cause the at least one processor to perform flight control of the unmanned aerial vehicle so as to move away from the identified first obstacle.

2. A flight control device according to claim 1, wherein the identification code is configured to cause the at least one processor to identify the first obstacle on the basis of height of a ground feature present in the vicinity of the unmanned aerial vehicle.

3. A flight control device according to claim 2, wherein the identification code is configured to cause the at least one processor to identify the height of the ground feature from map data around the unmanned aerial vehicle, and to identify the first obstacle on the basis of the identified height.

4. A flight control device according to claim 1, wherein the acquisition code is configured to cause the at least one processor to sequentially acquire, as the parameter value, a capture number of the one or more positioning satellites, and
the identification code is configured to cause the at least one processor to sequentially compare the acquired capture numbers with a first threshold value, and to identify the first obstacle in response to that the acquired capture number is less than or equal to the first threshold value.

5. A flight control device according to claim 1, wherein the acquisition code is configured to cause the at least one processor to sequentially acquire, as the parameter value, a reduction rate of the positioning accuracy, and
the identification code is configured to cause the at least one processor to sequentially compare the acquired reduction rates with a second threshold value, and to identify the first obstacle in response to that the acquired reduction rate is greater than the second threshold value.

6. A flight control device according to claim 1, wherein the flight control code is configured to cause the at least one processor to perform, in response to that a value obtained by subtracting an altitude of the unmanned aerial vehicle from height of the first obstacle is greater than or equal to 0 and the obtained value is less than or equal to a third threshold value, the flight control of the unmanned aerial vehicle such that the unmanned aerial vehicle vertically ascends.

7. A flight control device according to claim 1, wherein the flight control code is configured to cause the at least one processor to perform, in response to that a value obtained by subtracting an altitude of the unmanned aerial vehicle from height of the first obstacle is greater than or equal to 0 and the obtained value is greater than a third threshold value, the flight control of the unmanned aerial vehicle such that the unmanned aerial vehicle moves horizontally away from the first obstacle while ascending.

8. A flight control device according to claim 1, wherein the flight control code is configured to cause the at least one processor to perform, in response to that height of the first obstacle is less than or equal to a third threshold value, the flight control of the unmanned aerial vehicle such that the unmanned aerial vehicle vertically ascends.

9. A flight control device according to claim 1, wherein the flight control code is configured to cause the at least one processor to perform, in response to that height of the first obstacle is greater than a third threshold value, the flight control of the unmanned aerial vehicle such that the unmanned aerial vehicle moves horizontally away from the first obstacle while ascending.

10. A flight control device according to claim 7, wherein the flight control code is configured to cause the at least one processor to calculate, in response to detecting a second obstacle present in a direction away from the first obstacle, an ascent angle at which the unmanned aerial vehicle does not collide with the second obstacle, and to perform the flight control of the unmanned aerial vehicle such that the unmanned aerial vehicle ascends at the calculated ascent angle.

11. A flight control device according to claim 7, wherein the flight control code is configured to cause the at least one processor to perform, in response to detecting a second obstacle present in a direction away from the first obstacle, the flight control of the unmanned aerial vehicle such that the unmanned aerial vehicle ascends through a central portion between the first obstacle and the second obstacle.

12. A flight control device according to claim 4, wherein the flight control code is configured to cause the at least one processor to perform, in response to that the capture number is greater than or equal to the first threshold value due to the unmanned aerial vehicle ascending in accordance with the flight control, the flight control of the unmanned aerial vehicle such that the unmanned aerial vehicle gradually descends to a predetermined point.

13. A flight control device according to claim 5, wherein the flight control code is configured to cause the at least one processor to perform, in response to that the reduction rate is less than or equal to the second threshold value due to the unmanned aerial vehicle ascending in accordance with the flight control, the flight control of the unmanned aerial vehicle such that the unmanned aerial vehicle gradually descends to a predetermined point.

14. A flight control device according to claim 1, wherein the flight control code is configured to cause the at least one processor to identify a waypoint where the reduction of the positioning accuracy is forecasted to be recovered among waypoints to be passed on a flight route of the unmanned aerial vehicle, and to perform the flight control of the unmanned aerial vehicle toward the identified waypoint while avoiding the identified first obstacle.

15. A flight control device according to claim 14, wherein the flight control code is configured to cause the at least one processor to acquire a forecasted capture number of the positioning satellites that can be captured at each of the waypoints to be passed on the flight route, and to identify, as the waypoint where the reduction of the positioning accuracy is forecasted to be recovered, a waypoint where the acquired forecasted capture number is greater than or equal to a first threshold value.

16. A flight control device according to claim 15, wherein the flight control code is configured to cause the at least one processor to set a fourth threshold value greater than the first threshold value, and to identify, as the waypoint where the reduction of the positioning accuracy is forecasted to be recovered, a waypoint where the acquired forecasted capture number is greater than or equal to the fourth threshold value.

17. A flight control device according to claim 14, wherein the flight control code is configured to cause the at least one processor to acquire a forecasted reduction rate of the positioning accuracy at each of the waypoints to be passed on the flight route, and to identify, as the waypoint where the reduction of the positioning accuracy is forecasted to be recovered, a waypoint where the acquired forecasted reduction rate is less than or equal to a second threshold value.

18. A flight control device according to claim 17, wherein the flight control code is configured to cause the at least one processor to acquire set a fifth threshold value less than the second threshold value, and to identify, as the waypoint where the reduction of the positioning accuracy is forecasted to be recovered, a waypoint where the acquired forecasted reduction rate is less than or equal to the fifth threshold value.

19. A flight control method executed by one or more computers comprising:
sequentially acquiring, as satellite information relating to one or more positioning satellites, a parameter value that is an indicator of positioning accuracy on the basis of information on radio waves from the positioning satellites captured by an unmanned aerial vehicle in flight;
identifying a first obstacle that prevents reception of the radio waves in a vicinity of the unmanned aerial vehicle in response to that the parameter value falls under a situation that indicates reduction of the positioning accuracy; and
performing flight control of the unmanned aerial vehicle so as to move away from the identified first obstacle.

20. An unmanned aerial vehicle capable of autonomous flight comprising:
at least one memory configured to store program code; and at least one processor configured to access the program code and operate as instructed by the program code, the program code including:
acquisition code configured to cause the at least one processor to sequentially acquire, as satellite information relating to one or more positioning satellites, a parameter value that is an indicator of positioning accuracy on the basis of information on radio waves from the positioning satellites captured by an unmanned aerial vehicle in flight;
identification code configured to cause the at least one processor to identify a first obstacle that prevents reception of the radio waves in a vicinity of the unmanned aerial vehicle in response to that the parameter value falls under a situation that indicates reduction of the positioning accuracy; and
flight control code configured to cause the at least one processor to perform flight control of the unmanned aerial vehicle so as to move away from the identified first obstacle.
